(19) United States
(12) Patent Application Publication
(10) Pub. No.: US 2025/0298492 A1
(43) Pub. Date: Sep. 25, 2025

(54) MULTIPLE ASPECT RATIO IMAGE SYSTEM

(71) Applicant: Visual Supply Company, San Francisco, CA (US)

(72) Inventors: Samuel Peter Wick, Longmont, CO (US); Jared S. Smith, Vallejo, CA (US)

(21) Appl. No.: 18/611,379

(22) Filed: Mar. 20, 2024

(51) Int. Cl. G06F 3/0482; G06F 3/04817; G06F 3/04845; G06T 11/60

(52) U.S. Cl. CPC G06F 3/0482; G06F 3/04817; G06F 3/04845; G06T 11/60; G06F 2203/04804; G06T 2200/24; G06T 2210/12; G06T 2210/62

(57) ABSTRACT

Systems and methods are directed to generating and utilizing an interactive aspect ratio user interface presenting a range of aspect ratios that are applied to an image at the same time. The image system access an image and generates for display a user interface that includes the image and an adjust tools portion, whereby the adjust tools portion including aspect ratios. The image system receives, via the user interface, a selection of a plurality of the aspect ratios for application to the image. In response to receiving the selection of the plurality of aspect ratios, the image system generates an image preview that applies the plurality of aspect ratios to the image at the same time and updates the user interface to display the image preview. In one implementation, the image preview comprises an aspect ratio overlay that includes a bounding box for each of the plurality of aspect ratios.

### TECHNICAL FIELD

The subject matter disclosed herein generally relates to image processing. Specifically, the present disclosure addresses systems and methods that generate and display an aspect ratio user interface presenting a range of aspect ratios that are applied to an image at the same time.

### BACKGROUND

Comparison is a powerful tool in creating/editing images (e.g., art, photographs). Because visual art inherently does not have a right or wrong answer, users partake in a subjective act in deciding what edit is best for their images. Comparing different edits can be a very effective technique for deciding which edit best suits a user's intent. Comparing can be achieved in several ways. For instance, an image before and after an edit is applied can be compared, whereby the user views both versions but not at the same time. In most photo editing systems, the user can select different aspect ratios to crop their image. Typically, the user needs to apply each aspect ratio separately to understand how each one affects their image (e.g., before and after comparison).

### BRIEF DESCRIPTION OF THE DRAWINGS

The patent or application file contains at least one drawing executed in color. Copies of this patent or patent application publication with color drawings will be provided by the Office upon request and payment of the necessary fee.

Some implementations are illustrated by way of example and not limitation in the figures of the accompanying drawings.

FIG. 1 is a diagram illustrating an example network environment suitable for generating and displaying an aspect ratio user interface for displaying multiple aspect ratios applied to a same image at the same time, according to example implementations.

FIG. 2 is a diagram illustrating an example image system, according to example implementations.

FIG. 3A illustrates an aspect ratio user interface for displaying multiple aspect ratios applied to the same image at the same time, according to example implementations.

FIG. 3B illustrates an adjust tools panel of the aspect ratio user interface, according to example implementations.

FIG. 4A-FIG. 4D illustrates use of an aspect ratio overlay on an image displayed on the aspect ratio user interface, according to one example implementation.

FIG. 4E illustrates the aspect ratio user interface displaying multiple versions of the image with different aspect ratios, according to one example implementation.

FIG. 5 is a flowchart illustrating operations of a method for providing multiple aspect ratios for an image using an aspect ratio overlay, according to example implementations.

FIG. 6 is a flowchart illustrating operations of a method for providing multiple aspect ratios for the image to be exported to an external site, according to example implementations.

FIG. 7 is a block diagram illustrating components of a machine, according to some examples, able to read instructions from a machine-storage medium and perform any one or more of the methodologies discussed herein.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

Systems and methods that generate and display an aspect ratio user interface configured to show a range of aspect ratios graphically applied to an image at the same time are discussed herein. Comparing different edits can be a very effective technique for deciding which edit best suits a user's intent. Comparing can be achieved in several ways. A first manner it to compare an image before and after an edit is applied. The user can view both versions of the image but not at the same time. A second manner of comparison is to compare images side by side, thus enabling a user to view the different versions at the same time. Example implementations use aspects of the second version and a third version of comparison that shows different versions of edits, in this case aspect ratios, applied at the same time on the same image.

One example implementation provides an image system that generates an aspect ratio overlay and applies the aspect ratio overlay to an image on a user interface. The aspect ratio overlay can comprise two or more standard aspect ratios (e.g., 9:16, 2:3, 3:4, 4:5, 1:1) or custom entered aspect ratios that are displayed over the same image at the same time. The aspect ratio overlay is displayed on a user device such that a user can easily view the range of the aspect ratios on the image. One of the aspect ratios can be selected to update the user interface to display the image cropped to the selected aspect ratio. A bounding box of the selected aspect ratio can also be moved, expanded, and/or contracted to change a view of the cropped image.

A further implementation can display different versions of the image having different aspect ratios at the same time. In some cases, the different versions are automatically determined by the system based on intended use or destination of the image. For example, if the user intends to post the image to a social networking site (e.g., TikTok, Instagram, X, Facebook), the aspect ratios best suited for the social networking site are determined by the system and automatically applied to the image. In another example, if the user intends to obtain physical prints of the image, the system automatically applies aspect ratios that correspond to different physical print sizes (e.g., 2:3, 4:5, 5:7).

As a result, example implementations provide a technical solution to the technical problem of displaying different aspect ratios of an image in a digital format that allows for easy comparison. In particular, the technical solution employs an image system that generates an aspect ratio user interface that displays two or more aspect ratios applied to the same image at the same time. As a result, multiple images having different aspect ratios applied thereon do not need to be generated sequentially in order to compare the differences in application of different aspect ratios. Additionally, a user does not need to change aspect ratios multiple times before arriving at an optimal aspect ratio to apply to the image as a whole. As such, one or more of the methodologies described herein may obviate a need for certain efforts or computing resources that otherwise would be involved in generating multiple versions of an image having different aspect ratios for sequential display. Examples of such computing resources include processor cycles, memory usage, data storage capacity, power consumption, and network bandwidth.

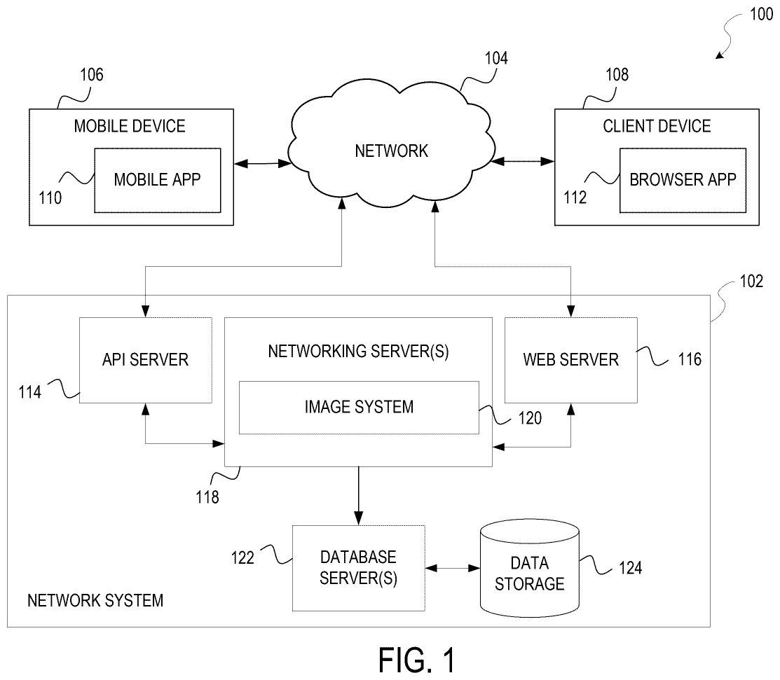

FIG. 1 is a diagram illustrating an example network environment 100 suitable for generating and displaying an aspect ratio user interface for displaying multiple aspect ratios applied to an image at the same time, according to example implementations. A network system 102 provides server-side functionality via a communication network 104 (e.g., the Internet, wireless network, cellular network, or a Wide Area Network (WAN)) to mobile devices 106 and client devices 108. The network system 102 is configured to provide editing functionalities to various users of the mobile devices 106 and client devices 108, as will be discussed in more detail below.

In various cases, the mobile device 106 is a device associated with a user account of a user of the network system 102 that wants to edit their images using functionalities of the network system 102. The mobile device 106 may comprise, but is not limited to, a smartphone that comprises one or more mobile applications 110 that communicate with the network system 102 for added functionality. In one implementation, the mobile application 110 comprises a communication component that exchanges data with the network system 102. For example, the mobile application 110 may be a local version of an application or component of the network system 102. Alternatively, the mobile application 110 exchanges data with one or more corresponding components/applications at the network system 102. The mobile application 110 may be provided by the network system 102 and/or downloaded to the mobile device 106.

The client device 108 may comprise, but is not limited to, a tablet, laptop, multi-processor systems, microprocessor-based or programmable consumer electronics, a desktop computer, a server, or any other communication device that can access the network system 102 via a browser. The client device 108 includes a browser application 112 that exchanges data, via the network 104, with the network system 102. For example, the browser application 112 can provide data to and access data from one or more components or applications at the network system 102. Additionally or alternatively, the client device 108 can include an image application that functions similar to the mobile application 110. Collectively, the mobile device 106 and the client device 108 are referred to herein as a “user device.”

In example implementations, the user devices interface with the network system 102 via a connection with the network 104. Depending on the form of the user device, any of a variety of types of connections and networks 104 may be used. For example, the connection may be Code Division Multiple Access (CDMA) connection, a Global System for Mobile communications (GSM) connection, or another type of cellular connection. Such a connection may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks, 5G networks). When such technology is employed, the network 104 includes a cellular network that has a plurality of cell sites of overlapping geographic coverage, interconnected by cellular telephone exchanges. These cellular telephone exchanges are coupled to a network backbone (e.g., the public switched telephone network (PSTN), a packet-switched data network, or other types of networks.

In another example, the connection to the network 104 is a Wireless Fidelity (e.g., Wi-Fi, IEEE 802.11x type) connection, a Worldwide Interoperability for Microwave Access (WiMAX) connection, or another type of wireless data connection. In such an example, the network 104 includes one or more wireless access points coupled to a local area network (LAN), a wide area network (WAN), the Internet, or another packet-switched data network. In yet another example, the connection to the network 104 is a wired connection (e.g., an Ethernet link) and the network 104 is a LAN, a WAN, the Internet, or another packet-switched data network. Accordingly, a variety of different configurations are expressly contemplated.

Additionally, the user device comprises a display component (not shown) to display information (e.g., in the form of user interfaces) as will be discussed in more detail below. The user device can be operated by a human user and/or a machine user.

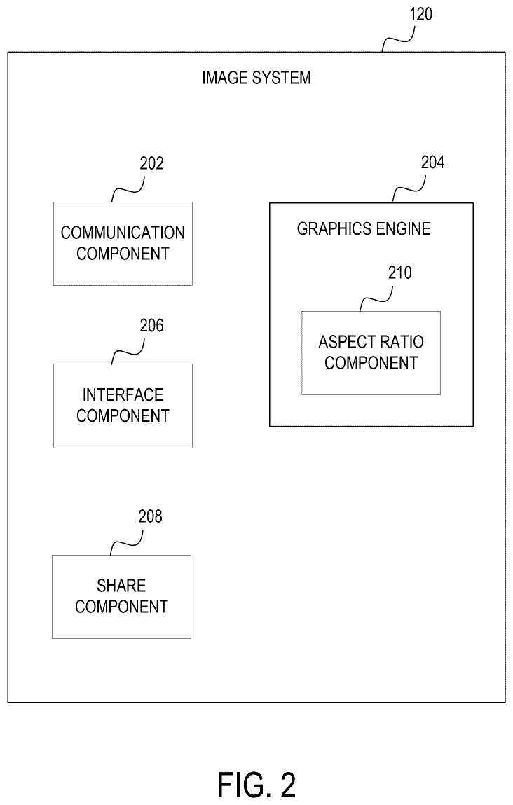

Turning specifically to the network system 102, an application programing interface (API) server 114 and a web server 116 are coupled to and provide programmatic and web interfaces respectively to one or more networking servers 118. The networking server(s) 118 host various systems including an image system 120, which comprises a plurality of components and which can be embodied as hardware, software, firmware, or any combination thereof. The image system 120 is configured to manage the editing of images by the network system 102. In particular, the image system 120 generates and displays an aspect ratio user interface that presents different aspect ratios applied to the image at the same time. The image system 120 will be discussed in more detail in connection with FIG. 2 below.

The networking server(s) 118 can be, in turn, coupled to one or more database servers 122 that facilitate access to one or more storage repositories or data storage 124. The data storage 124 is a storage device storing, for example, user accounts including user profiles of users of the network system 102 and corresponding saved images of these users.

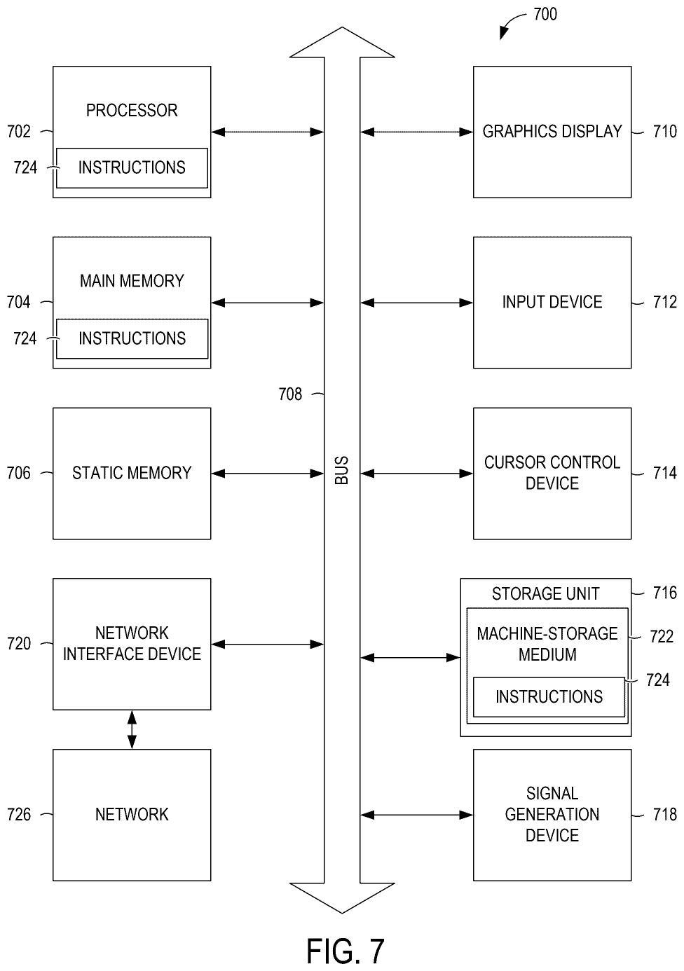

Any of the systems, data storage, or devices (collectively referred to as “components”) shown in, or associated with, FIG. 1 may be, include, or otherwise be implemented in a special-purpose (e.g., specialized or otherwise non-generic) computer that can be modified (e.g., configured or programmed by software, such as one or more software components of an application, operating system, firmware, middleware, or other program) to perform one or more of the functions described herein for that system or machine. For example, a special-purpose computer system able to implement any one or more of the methodologies described herein is discussed below with respect to FIG. 7, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined, and the functions described herein for any single component may be subdivided among multiple components. Functionalities of one system may, in alternative examples, be embodied in a different system. Additionally, any number of mobile devices 106, client devices 108, and data storage 124 may be embodied within the network environment 100. While only a single network system 102 is shown, alternatively, more than one network system 102 can be included (e.g., localized to a particular region).

FIG. 2 is a diagram illustrating components of the image system 120, according to example implementations. The image system 120 processes images, performs edits to the images, and presents different user interfaces for performing the edits including generating and displaying an aspect ratio user interface. To enable these operations, the image system 120 comprises a communication component 202, a graphics engine 204, an interface component 206, and a share component 208 all configured in communication with one another (e.g., via a bus, shared memory, or a switch). The image system 120 may comprise other components (not shown) that are not germane to the aspect ratio implementations.

The communication component 202 is configured to exchange data with other components of the network environment 100. Thus, the communication component 202 receives, from the mobile application 110 operating on the mobile device 106 or via the browser application 112 operating on the client device 108, a request to view and edit images. In some cases, the request includes the image to be edited. In other cases, the request indicates an image that has been previously provided (e.g., uploaded) to the network system 102 (via the communications component 202) and stored in the data storage 124. In some cases, the communication component 202 may also receive inputs that indicate operations that a user wants performed on their image. For example, the inputs can indicate to crop or rotate an image, change one or more effects applied to the image, save an edited image, apply different aspect ratios, and so forth.

The graphics engine 204 is configured to perform edits or modifications to images based on user inputs and generate the edited images for display. For example, the graphics engine 204 can apply one or more effects to an image, crop an image, apply filters, blur an image, apply different aspect ratios, or perform other adjustments to the images. In some implementations, the graphics engine 204 generates an aspect ratio overlay and/or multiple versions of an image having different aspect ratios. For these implementations, the graphics engine 204 includes an aspect ratio component 210. The graphics engine 204 can include other components (not shown) that perform other types of image processing (e.g., editing and modification) not related to the aspect ratios.

In example implementations, the aspect ratio component 210 determines and provides aspect ratios that can be applied to an image. The aspect ratios may comprise standard aspect ratios (e.g., 9:16, 2:3, 3:4, 4:5, 1:1, 16:9. 3:2. 4:3, 5:4). In some cases, the aspect ratios may differ based on an intended use of the image. For example, if the user intends to print the image as a photograph, the aspect ratio component 210 may only present aspect ratios that correspond to print sizes. In another example, if the user intends to post the image to a social networking site (e.g., TikTok, Instagram, X), the aspect ratios best suited for the corresponding social networking site are determined by the aspect ratio component 210. These aspect ratios may be stored (e.g., in the data storage 124) and accessed when needed.

The available aspect ratios are displayed on the user device via an aspect ratio user interface generated by the interface component 206. In example implementations, the aspect ratio component 210 allows a user to select multiple aspect ratios to be applied to a single image at the same time. For example, the user can individually select two or more aspect ratios or select an “all option” that displays all the available aspect ratios at the same time. In some implementations, the aspect ratio component 210 may allow the user to enter one or more custom aspect ratios.

In one implementation, the aspect ratio component 210 generates an image preview that shows an aspect ratio overlay that includes all of the selected aspect ratios positioned over the image. The image may be shown as translucent with the aspect ratio overlay applied. Once the user selects one of the aspect ratios to preview its application, a portion of the image within a bounding box of the selected aspect ratio is made transparent by the aspect ratio component 210. The user can change the aspect ratio which causes a different portion of the image to become transparent.

In another implementation, the aspect ratio component 210 generates a plurality of different versions of the same image in the aspect ratio preview, whereby each version has a different aspect ratio applied thereto. In this implementation, the plurality of different versions are shown at the same time allowing the user to visually compare the different versions in the aspect ratio preview. In some cases, the different versions are cropped to their respective aspect ratios. In other cases, the different versions can show the bounding box of the corresponding aspect ratio positioned over the entire image. This allows the user to adjust the bounding box, as will be discussed in more detail below.

The aspect ratio component 210 also allows the user to manipulate or adjust a selected aspect ratio. For example, the user can drag a corner of a bounding box to change a size of the portion of the image shown within the bounding box while maintaining the selected aspect ratio. The user can also move the bounding box to a different portion of the image to change what is displayed within the bounding box.

When the user is satisfied with the selected aspect ratio and the portion of the image that is visible within the bounding box, the user can apply the selected aspect ratio to the image. The application of the selected aspect ratio causes the aspect ratio component 210 to crop the image to the aspect ratio. In the implementation directed to exporting to an external site (e.g., social network or website), the share component 208 receives the cropped image from the graphics engine 204. The share component 208 may then transmit (e.g., uploads) the cropped image to the social network or website. Similarly, for an implementation directed to obtaining a physical copy of the cropped image (e.g., a photographic print), the share component 208 receives the cropped image and transmits (e.g., uploads) the cropped image to a printing entity (e.g., a printing website). In both of these implementations, the cropped image may be associated with or uploaded to an account of the user at the external site.

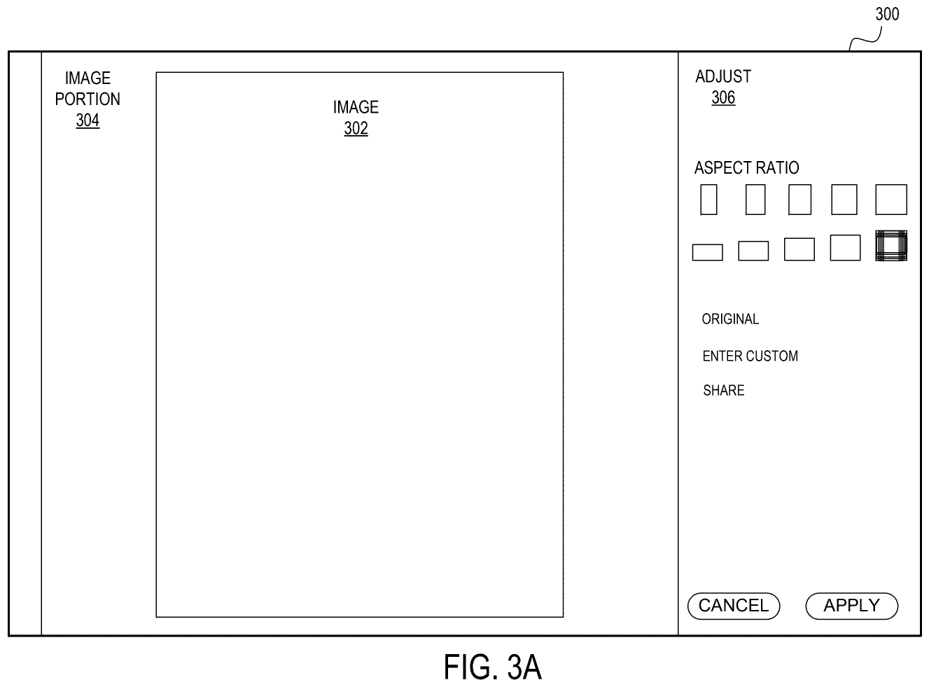

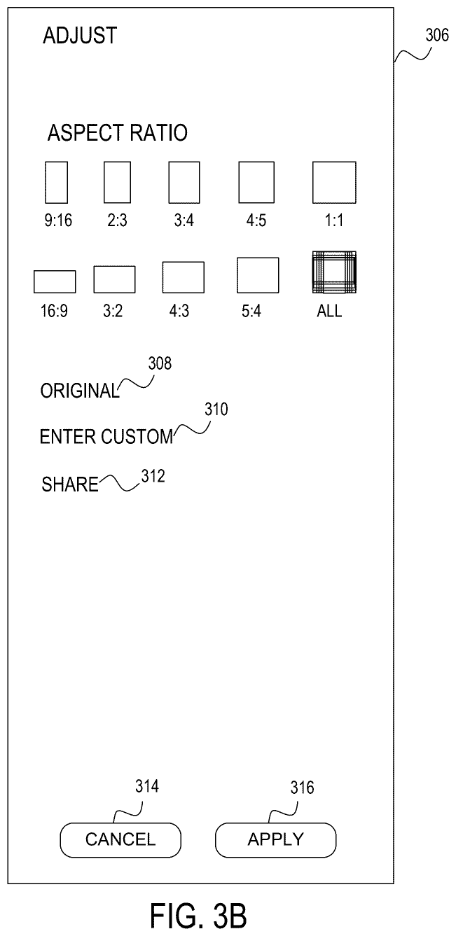

FIG. 3A illustrates an aspect ratio user interface 300 displayed on a user device for displaying multiple aspect ratios applied to a same image 302 at the same time, according to example implementations. The aspect ratio user interface 300 is generated and displayed (or transmitted to the user device for display depending on the implementation) by the interface component 206. In one implementation, the aspect ratio user interface 300 is reached via a higher-level user interface (e.g., preceding webpage or screen) where the user may have selected the image to edit and selected an option to adjust the aspect ratios.

The aspect ratio user interface 300 comprises an image portion 304 where the image 302 to be edited is displayed and an adjust tools panel 306. The adjust tools panel 306 comprises a plurality of available aspect ratios provided by the aspect ratio component 210. In some cases, the aspect ratios may differ based on an intended use of the image. For example, if the user intends to post the image to a social networking site (e.g., TikTok, Instagram, X), the aspect ratios best suited for the corresponding social networking site are determined by the aspect ratio component 210 and displayed in the adjust tools panel 306. The user's intention may be indicated in the adjust tools panel 306 or in the preceding webpage or screen. For example, the user may select an option that indicates to crop the image for use on social network or for printing.

Referring now to FIG. 3B, the adjust tools panel 306 is shown expanded and in more detail, in accordance with example implementations. The adjust tools panel 306 includes the different available aspect ratios graphically shown. In the example of FIG. 3B, the available aspect ratios include 9:16, 2:3, 3:4, 4:5, 1:1, 16:9. 3:2. 4:3, 5:4, and ALL. It is noted that more, less, or alternative aspect ratios can be included in other implementations of the adjust tools panel 306. The user can select any number of the aspect ratios to preview on the image. For example, the user can tap or click on one or more of the aspect ratios displayed in the adjust tools panel 306.

The selection of ALL (e.g., ALL icon) can cause generation of an aspect ratio overlay with all of the available aspect ratios to be presented over the image or generation of a different versions of the same image with all of the aspect ratios. In some cases, all of the available aspect ratios may only include the available aspect ratios having the same orientation as the image. For instance, if the image is in portrait mode, then “all” of the aspect ratios includes aspect ratios of 9:16, 2:3, 3:4, 4:5, 1:1. Similarly, if the image is in landscape mode, then “all” of the aspect ratios can include aspect ratios of 1:1, 16:9. 3:2. 4:3, 5:4. In other cases, “all” of the aspect ratios includes every available aspect ratio regardless of the orientation.

The adjust tools panel 306 also includes an original icon 308 (e.g., ORIGINAL). The selection of the ORIGINAL icon 308 returns the displayed image 302 to its original size. For example, assume the user has selected multiple aspect ratios and that a preview of the aspect ratios applied to the image is displayed in the image portion 304. The selection of the ORIGINAL icon 308 removes the preview of the aspect ratios and causes the display of the original image.

The adjust tools panel 306 can further include a custom icon 310 (e.g., ENTER CUSTOM). By selecting the custom icon 310, the user can enter one or more custom aspect ratios. For example, selection of the custom icon 310 can cause a field to be presented in which the user can enter the custom aspect ratio(s). The custom aspect ratios can be combined with any selected standard or predetermined (e.g., available) aspect ratios presented in the adjust tools panel (e.g., the user selects one or more standard aspect ratios and enters a custom aspect ratio).

The adjust tools panel 306 can also include a share icon 312 (e.g., SHARE). Selection of the share icon 312 provides an indication that the user wants to share or upload the image to another site. For example, the user may want to upload the image to a particular social networking or photo printing site. In some cases, selection of the share icon 312 causes an update to the adjust tools panel 306 to display a plurality of sites from which the user can select. In other cases, selection of the share icon 312 causes a field to be presented in which the user can enter the site they want the image sent to. More than one site can be selected for sharing.

Based on the site that the image will be share to, the aspect ratio component 210 determines the available aspect ratios. For example, if the user intends to print the image as a photograph, the aspect ratio component 210 may only present aspect ratios that correspond to print sizes. Alternatively, if the user intends to post the image to a social networking site (e.g., TikTok, Instagram, X), the aspect ratios best suited for the corresponding social networking site are determined by the aspect ratio component 210. The aspect ratios shown in the adjust tools panel 306 are dynamically updated to reflect the aspect ratios available for the site(s).

While the example of FIG. 3B shows the share icon 312 being embodied on the adjust tools panel 306 with the aspect ratio icons, alternative implementations may have the share icon 312 and its functionalities associated with a previous user interface or screen. In these alternative implementations, the indication of the external site that the image will be exported to can trigger the display of the aspect ratio user interface with the applicable aspect ratios presented thereon.

At a bottom of the adjust tools panel 306 is a cancel icon 314 and an apply icon 316. The cancel icon 314 cancels adjustments based on the application of the aspect ratios and can return the user to a preceding screen or higher-level user interface. The apply icon 316 can apply the selected aspect ratio to the image which causes the image to be cropped. In implementations where the cropped image will be shared, the apply icon 316 can trigger the export (e.g., upload) of the cropped image to the social network, photo printing site, or other external site. The apply icon 316 can also save the cropped image to an account of the user at the network system 102.

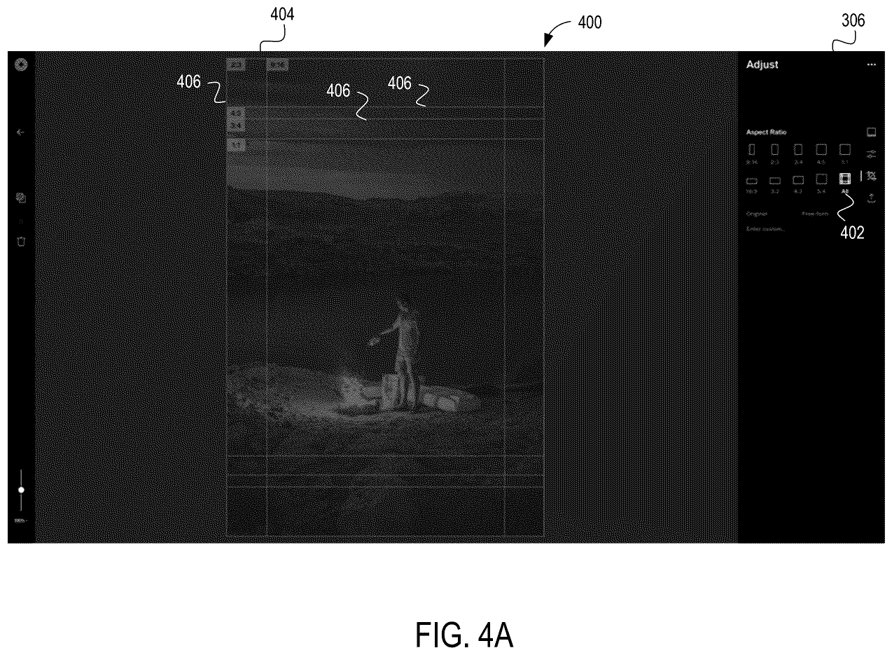

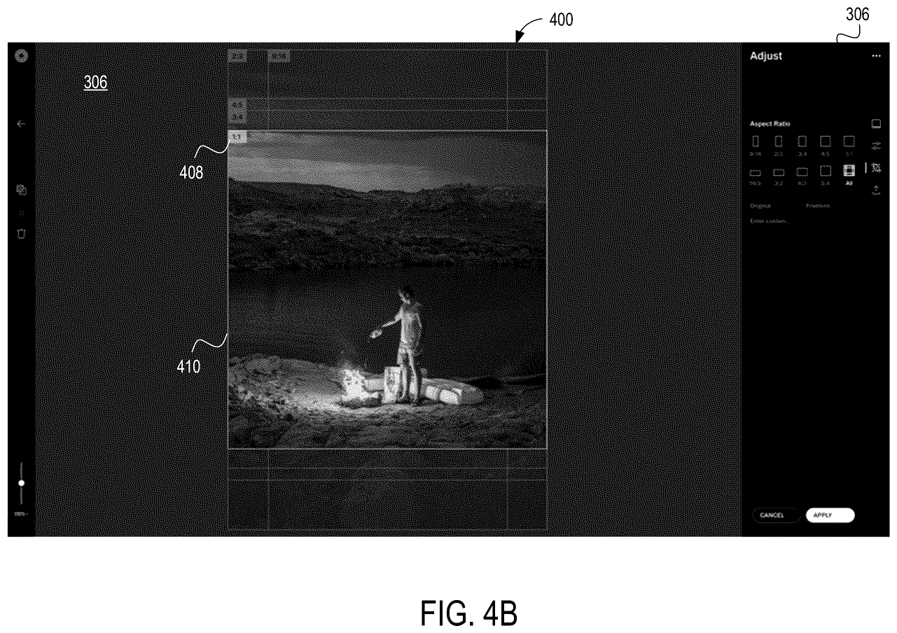

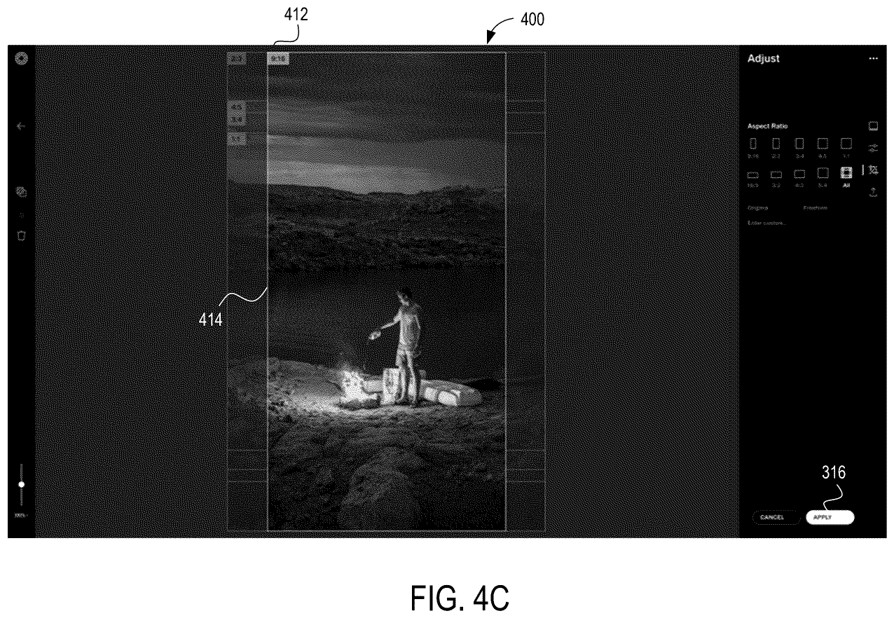

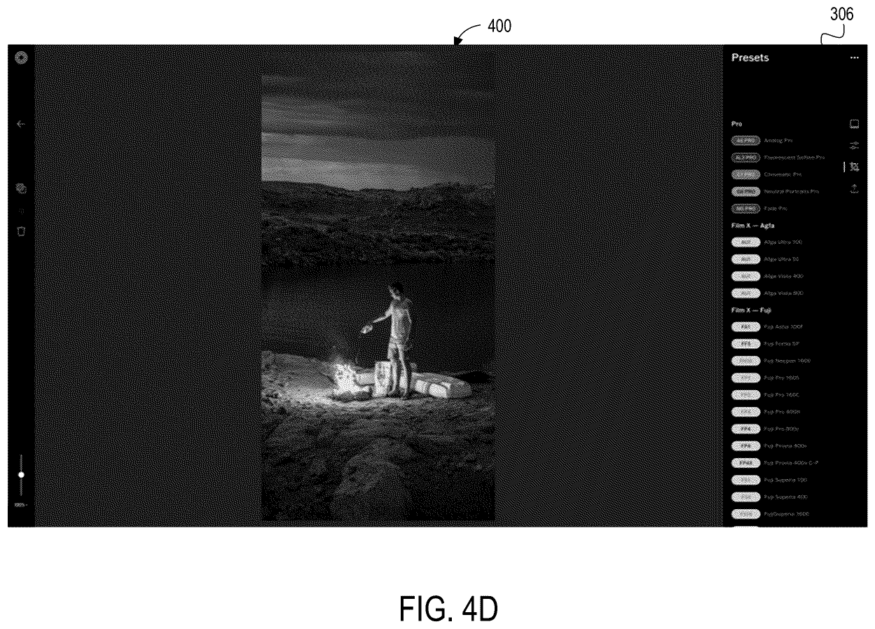

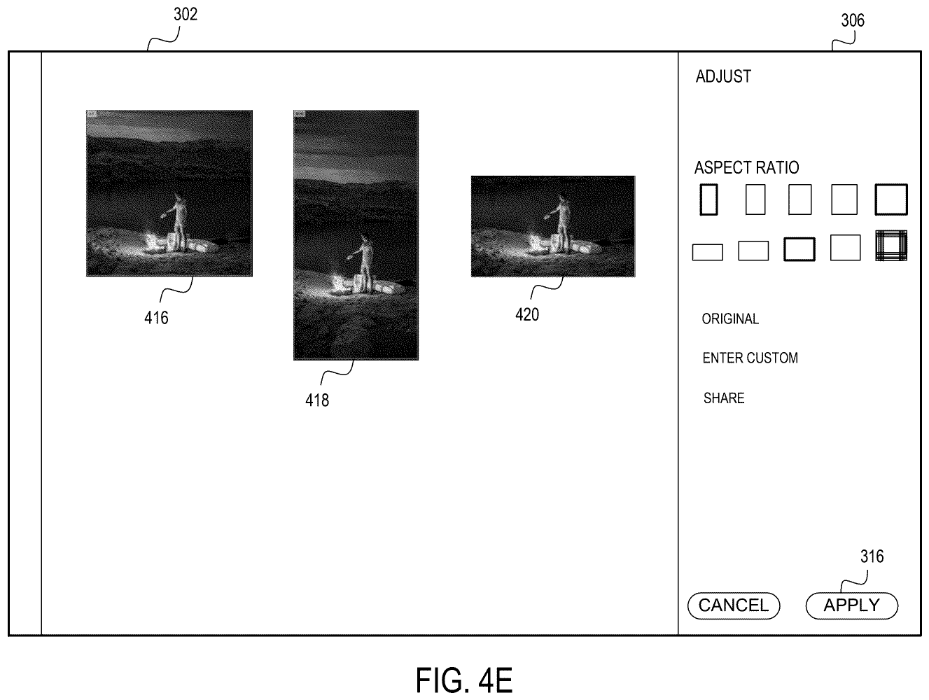

FIG. 4A-FIG. 4D illustrates use of the aspect ratio overlay on an image displayed on the multiple aspect ratio user interface, according to one example implementation. Referring to FIG. 4A, the image 400 selected for editing is displayed on the user interface. To a side of the image 400 is the adjust tools panel 306. In the example of FIG. 4A, the user has selected the ALL icon 402, which may cause the ALL icon 402 to be highlighted or otherwise visually distinguished. In response to the selection, the graphics engine 204 (e.g., aspect ratio component 210) generates an aspect ratio overlay 404 that comprises bounding boxes 406 for all of the available aspect ratios based on the orientation of the image 400. As shown, the image 400 is in portrait mode. Thus, the aspect ratios include 9:16, 2:3, 3:4, 4:5, 1:1. The aspect ratio overlay 404 gives a unique visualization of the different aspect ratios on the same image 400 at the same time using the bounding boxes 406 corresponding to each aspect ratio. This provides a unique view that quickly gives the user a sense of how different aspect ratios look on the image 400. The application of the aspect ratio overlay 404 over the image 400 causes the image 400 to be displayed translucent.

While the example of FIG. 4A shows the aspect ratio overlay 404 with only portrait-oriented aspect ratios, alternative implementations can generate and display the aspect ratio overlay 404 with both portrait and landscape-oriented aspect ratios.

Referring now to FIG. 4B, one of the aspect ratios is selected for preview. In the example of FIG. 4B, the selected aspect ratio is 1:1. In one implementation, the selection of the aspect ratio occurs by hovering a cursor over an aspect ratio indicator 408 or hovering a cursor over the corresponding aspect ratio in the adjust tools panel 306. In a mobile device implementation, selection may occur by tapping on the aspect ratio indicator 408 or the corresponding aspect ratio in the adjust tools panel 306. Selection of the aspect ratio causes a portion of the image 400 within a bounding box 410 of the selected aspect ratio to become transparent or pulled to a front of the image portion 304. Bounding boxes 406 of non-selected aspect ratios are still displayed but are pushed to the back of the image portion 304 (e.g., remain translucent) resulting in any portions of the image 400 not within the bounding box 410 to remain translucent.

The user can change the preview by hovering over a second aspect ratio. Referring now to FIG. 4C, the user now selects an aspect ratio of 9:16. For example, the user may hover the cursor over a second aspect ratio indicator 408 for the aspect ratio of 9:16 or hover the cursor over the 9:16 aspect ratio icon in the adjust tools panel 306. In a mobile device implementation, selection may occur by tapping on the aspect ratio indicator 412 or the 9:16 aspect ratio icon in the adjust tools panel 306. Selection of the second aspect ratio causes a portion of the image 400 within a bounding box 414 of the selected second aspect ratio to become transparent or pull to the front of the image portion 304. The remaining bounding boxes 406 of the non-selected aspect ratios are pushed to the back of the image portion 304 including the bounding box 410 of the previously selected aspect ratio (e.g., 1:1 aspect ratio) and made translucent. As a result, any portions of the image 400 not within the bounding box 414 becomes (or remains) translucent.

In some cases, the user may want the aspect ratio to include a different portion of the image 400. As such, the user can move the bounding box of the selected aspect ratio (e.g., bounding box 410 or 414) to a different portion of the image 400. In example implementations, the user can select the bounding box (e.g., click/tap on a side of the bounding box) and drag the bounding box around the image 400 to incorporate a desired portion of the image 400 within the bounding box.

In some cases, the user may want to resize the bounding box of the selected aspect ratio. In example implementations, the user can select or tap on a corner of the bounding box and move the corner to resize the bounding box. Thus, the user can pull the corner out to enlarge the bounding box or push the corner in to shrink the bounding box.

Once the user is satisfied with the selected aspect ratio displayed as a preview, the aspect ratio can be applied to the image 400. In some implementations, the user selects (e.g., clicks on or taps) the aspect ratio indicator (e.g., 408, 412) to apply the aspect ratio. In some implementations, the user can select the apply icon 316 in the adjust tools panel 306 to apply the aspect ratio. Further still, a user can double tap within the bounding box of the selected aspect ratio in the preview to apply the aspect ratio. In response to the selection of the aspect ratio indicator or the apply icon 416, the selected aspect ratio is applied to the image 400 as shown in FIG. 4D. In the example of FIG. 4D, the image 400 is cropped to the applied aspect ratio. The non-selected bounding boxes along with portions of the image 400 outside of the bounding box of the applied aspect ratio are removed from the image portion 306. In implementations where the image is to be exported to an external site, the selection of the apply icon 416 or a share icon, for example, can trigger the share component 208 to export the cropped image to the external site.

In an alternative implementation, the selection of more than one aspect ratio or the ALL icon 402 causes display of multiple versions of the image having different aspect ratios. FIG. 4E illustrates the aspect ratio user interface displaying multiple versions (416, 418, 420) of the image with different aspect ratios, according to one example implementation. For example, FIG. 4E shows a first version 416 of the image having an aspect ratio of 1:1, a second version 418 of the image having an aspect ratio of 9:16, and a third version 420 of the image having an aspect ratio of 4:3. The corresponding aspect ratio icons in the adjust tools panel 306 are visually distinguished (e.g., highlighted) to indicate that the aspect ratio is being previewed in the image portion 302.

In some cases, the aspect ratios for preview are selected by a user via the adjust tools panels, while in other cases, the different versions of the aspect ratio are automatically determined by the aspect ratio component 210 based on intended use or destination of the image. For instance, if the user intends to post the image to a social networking site or to order physical prints of the image from a photo print site, the graphics engine 204 automatically applies aspect ratios that correspond to the external site. The aspect ratio user interface of FIG. 4E may be presented on the user device with the multiple versions applicable to the intended use automatically previewed. The user can select one of the versions 416, 418, 420 for export to the external site. For example, the user can double click on one of the versions 416, 418, 420 or select (e.g., tap or click on) one of the versions 416, 418, 420 and select the apply icon 316 to export a cropped image of the selected aspect ratio to the external site.

In some implementations, the multiple versions may be illustrated using the aspect ratio overlay discussed in FIG. 4A. That is, all of the different aspect ratios that can be applied to the image 400 are included in the aspect ratio overlay. The user can then select one of the aspect ratios to preview the image as shown in FIG. 4B and FIG. 4C. Once the user is satisfied with the aspect ratio, the user can trigger export of a cropped image corresponding to the selected aspect ratio to the external site.

While the example of FIG. 4E shows the versions of the image with the corresponding aspect ratio applied thereto, an alternative implementation may show the entire image (e.g., without crop). In some cases, the different versions can show the bounding box of the corresponding aspect ratio positioned over the entire image. This allows the user to adjust the bounding box (e.g., move the bounding box, resize the bounding box) to capture the portion of the image that user wants viewable.

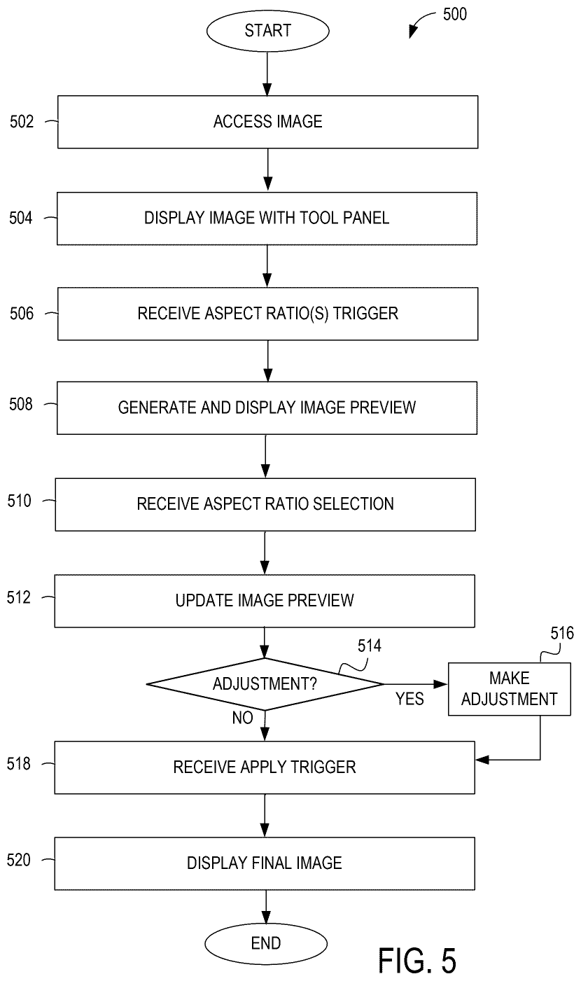

FIG. 5 is a flowchart illustrating operations of a method 500 for providing multiple aspect ratios for an image using an aspect ratio overlay, according to example implementations. Operations in the method 500 may be performed by the image system 120, using components described above with respect to FIG. 2. Accordingly, the method 500 is described by way of example with reference to the image system 120. However, it shall be appreciated that at least some of the operations of the method 500 may be deployed on various other hardware configurations or be performed by similar components residing elsewhere in the network environment 100. Therefore, the method 500 is not intended to be limited to the image system 120.

In operation 502, the image system 120 accesses an image to be edited. In some cases, the communication component 202 receives a request to edit an image along with the image. In other cases, the request indicates an image that has been previously provided (e.g., uploaded) to the network system 102 (via the communications component 202) and stored in the data storage 124. In these cases, the image system 120 (e.g., the graphics engine 204) accesses the image from the data storage 124.

In operation 504, the graphics engine 204 displays the image along with the adjust tools panel that includes available aspect ratios that can be applied to the image. In some cases, the available aspect ratios may be based on an orientation of the image. For example, if the image is in portrait mode, then the graphics engine 204 may only present aspect ratios that are appropriate for the portrait mode. In other cases, all standard aspect ratios, regardless of orientation, are provided.

In example implementations, the adjust tools panel may be displayed in response to activation of a trigger to adjust an aspect ratio of the image. In example implementations, the interface component 206 generates a user interface (e.g., aspect ratio user interface) and causes display (e.g., transmits the user interface over the network 104 to the user device) of the user interface on the user device. The user interface can be displayed via the mobile application 110 on the mobile device 106 or via the browser application 112 on the client device 108, for example.

In operation 506, the image system 120 receive an aspect ratio preview trigger. In example implementations, the aspect ratio preview trigger includes a selection of two or more aspect ratios to be applied to the image. For example, the user can select two or more aspect ratio displayed in the adjust tools panel, select an ALL icon, or select a share icon which, in some cases, allows the user to indicate one or more external sites that the user wants to export the image to. The selection of the share icon and/or the indication of the external site(s) causes the aspect ratio component 210 to access/determine appropriate aspect ratios for the external site(s).

In operation 508, the aspect ratio component 210 generates an image preview that shows an aspect ratio overlay that includes all of the selected or determined aspect ratios. The aspect ratio overlay is positioned over the image in the image preview causing the image to be shown as translucent. The aspect ratio overlay shows different bounding boxes corresponding to each selected aspect ratio. In some cases, the different bounding boxes are shown translucent until selected. In other cases, the different bounding boxes can be shown with different colors, portions of the image within the bounding boxes may be shown with different opacities, or some other visual difference can be used to distinguish the different aspect ratios applied to the image.

In operation 510, the image system 120 receives an aspect ratio selection for preview. In one implementation, the selection of the aspect ratio occurs by hovering a cursor over an aspect ratio indicator (e.g., aspect ratio indicator 408) or hovering a cursor over the corresponding aspect ratio in the adjust tools panel 306. In a mobile device implementation, selection may occur by tapping on the aspect ratio indicator or the corresponding aspect ratio in the adjust tools panel 306.

In operation 512, the graphics engine 204 updates the displayed image preview based on the aspect ratio selection. Specifically, the graphics engine 204 causes a portion of the image 400 within a bounding box of the selected aspect ratio to become transparent or pulled to a front of the image portion of the aspect ratio user interface. Bounding boxes of non-selected aspect ratios and portions of the image not within the bounding box of the selected aspect ratio are still displayed but are pushed to the back of the image portion resulting in any portions of the image 400 not within the bounding box 410 to remain translucent. It is noted that the user can change the image preview by hovering over a second aspect ratio.

In operation 514, a determination is made whether an adjustment to a bounding box is detected. In some cases, the user can move the bounding box of the selected aspect ratio to a different portion of the image. For example, the user selects the bounding box (e.g., click/tap on the bounding box) and drags the bounding box to incorporate a desired portion of the image 400 within the bounding box. In some cases, the user may want to resize the bounding box of the selected aspect ratio. For instance, the user selects or taps a corner of the bounding box and moves the corner to resize the bounding box (e.g., pull the corner out to enlarge the bounding box or push the corner in to shrink the bounding box). If an adjustment is detected in operation 514, the adjustment is made by the graphics engine 204 in operation 516.

If no adjustments are detected in operation 514 and the user is satisfied with the selected aspect ratio displayed in the image preview, then the graphic engine 204 receives an apply trigger in operation 518. The apply trigger applies the selected aspect ratio to the image. For example, the user selects (e.g., clicks on or taps) the aspect ratio indicator to apply the aspect ratio. In some implementations, the user selects an apply icon (e.g., apply icon 416) in the adjust tools panel to apply the aspect ratio. Further still, a user can double tap within the bounding box of the selected aspect ratio in the image preview to apply the aspect ratio.

In response to the selection of the aspect ratio indicator, double tap, or selection of the apply icon 416, the selected aspect ratio is applied to the image in operation 520 and the final image displayed on the aspect ratio user interface. Specifically, the image 400 is cropped to the applied aspect ratio and the non-selected bounding boxes along with portions of the image outside of the bounding box of the applied aspect ratio are removed from the image portion. In some implementations, the application of the aspect ratio causes the cropped image to be stored (e.g., to data storage 124) and associated with an account of the user.

While the method 500 of FIG. 5 has been described above with the use of the aspect ratio overlay, an alternative embodiment can use multiple versions of the image instead of the aspect ratio overlay. Thus, in operation 508, the image preview can comprise multiple versions of the image having the different aspect ratios applied thereto. The multiple versions can be displayed side by side so as to allow visual comparison of the different versions. Selection of an aspect ratio in operation 510 may result in the corresponding version being enlarged and the non-selected aspect ratios to be removed from the image preview. Adjustments, if needed, can be made and the apply trigger activated to finalize the application of the aspect ratio to the image.

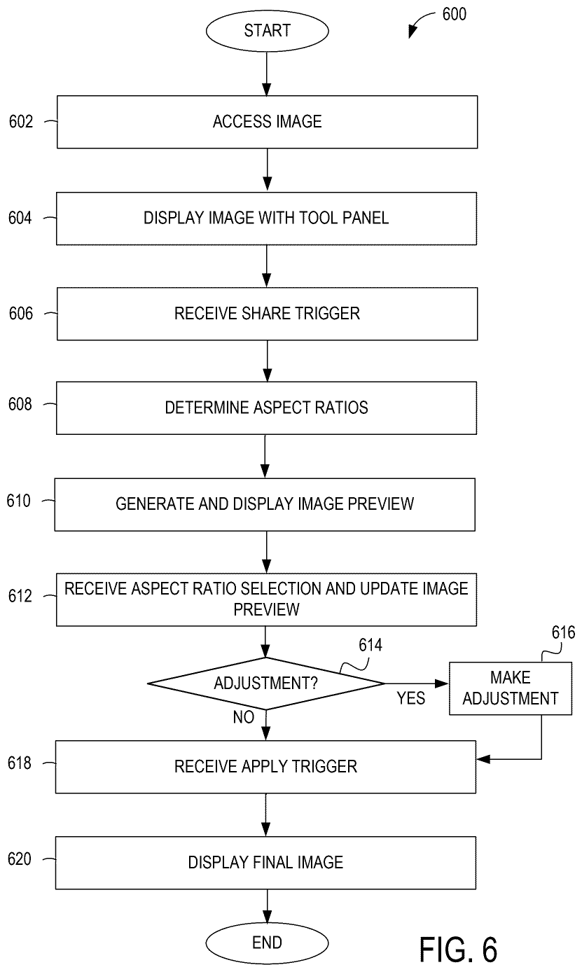

FIG. 6 is a flowchart illustrating operations of a method 600 for providing multiple aspect ratios for an image to be exported to an external site, according to example implementations. Operations in the method 600 may be performed by the image system 120, using components described above with respect to FIG. 2. Accordingly, the method 600 is described by way of example with reference to the image system 120. However, it shall be appreciated that at least some of the operations of the method 600 may be deployed on various other hardware configurations or be performed by similar components residing elsewhere in the network environment 100. Therefore, the method 600 is not intended to be limited to the image system 120.

In operation 602, the image system 120 accesses an image to be edited. In some cases, the communication component 202 receives a request to edit an image along with the image. In other cases, the request indicates an image that has been previously provided (e.g., uploaded) to the network system 102 (via the communications component 202) and stored in the data storage 124. In these cases, the image system 120 (e.g., the graphics engine 204) accesses the image from the data storage 124.

In operation 604, the graphics engine 204 displays the image along with the adjust tools panel that includes available aspect ratios that can be applied to the image. In example implementations, the adjust tools panel may be displayed in response to activation of a trigger to adjust an aspect ratio of the image. In some cases, the available aspect ratios may be based on an orientation of the image. In other cases, all standard aspect ratios, regardless of orientation, are provided.

In operation 606, the image system 120 receives a share trigger. In example implementations, the adjust tools panel 306 can include a share icon. Selection of the share icon provides an indication that the user wants to share or upload the image to an external site (e.g., a particular social network or to a photo printing site). In some cases, selection of the share icon causes an update to the adjust tools panel 306 to display a plurality of sites from which the user can select or a field in which the user can enter the site they want the image sent to. More than one site can be selected for sharing.

Based on the site that the image will be exported to, the aspect ratio component 210 determines the available aspect ratios in operation 608. For example, if the user intends to print the image as a photograph, the aspect ratio component 210 may only present aspect ratios that correspond to print sizes. Alternatively, if the user intends to post the image to a social networking site (e.g., TikTok, Instagram, X), the aspect ratios best suited for the corresponding social networking site are determined by the aspect ratio component 210. The aspect ratios shown in the adjust tools panel 306 may be dynamically updated to reflect the aspect ratios available for the site(s).

In operation 610, the aspect ratio component 210 generates an image preview. In some cases, the image preview shows an aspect ratio overlay that includes all of the selected or determined aspect ratios. The aspect ratio overlay is positioned over the image in the image preview causing the image to be shown as translucent and includes different bounding boxes corresponding to each selected aspect ratio. In other cases, the image preview can comprise multiple versions of the image having the different aspect ratios applied thereto and shown side by side.

In some implementations, operation 610 is automatically performed after the aspect ratios are determined in operation 608. For example, the user may indicate that the image is to be exported to a particular social network (e.g., Facebook, Instagram, X). The aspect ratio component 210 determines the appropriate aspect ratios for the particular social network and, instead of or in addition to updating the adjust tools panel to show the appropriate aspect ratios, these aspect ratios are automatically applied to the image in operation 610.

In other implementations, operation 610 is triggered by the user. For example, the user may select two of more aspect ratios from the adjust tools panel for application.

In operation 612, the image system 120 receives an aspect ratio selection and updates the displayed image preview based on the aspect ratio selection. The graphics engine 204 can cause a portion of the image 400 within a bounding box of the selected aspect ratio to become transparent or pulled to a front of the image portion of the aspect ratio user interface. Alternatively, in the multiple version implementation, the graphics engine 204 causes the version of the selected aspect ratio to become enlarged in view compared to the non-selected versions.

In operation 614, a determination is made whether an adjustment is detected. In some cases, the user moves the bounding box of a selected aspect ratio to a different portion of the image. In some cases, the user may resize the bounding box of the selected aspect ratio. For instance, the user selects or taps a corner of the bounding box and moves the corner to resize the bounding box (e.g., pull the corner out to enlarge the bounding box or push the corner in to shrink the bounding box). If an adjustment is detected in operation 614, the adjustment is made in operation 616.

If no adjustments are detected in operation 614 and the user is satisfied with the selected aspect ratio displayed as a preview, then the graphic engine 204 receives an apply trigger in operation 618. The apply trigger applies the selected aspect ratio to the image. For example, the user selects (e.g., clicks on or taps) the aspect ratio indicator to apply the aspect ratio. In some implementations, the user can select an apply icon (e.g., apply icon 416) in the adjust tools panel to apply the aspect ratio. Further still, a user can double tap within the bounding box of the selected aspect ratio in the preview to apply the aspect ratio.

In response to the selection of the aspect ratio indicator, double tap, or selection of the apply icon, the selected aspect ratio is applied to the image in operation 620 and the final image may be exported to the external site. Additionally, the final image is displayed on the aspect ratio user interface, whereby the image is cropped to the selected aspect ratio and any non-selected bounding boxes and/or versions are removed from the image portion. In some implementations, the selection of the aspect ratio can also cause the cropped image to be stored (e.g., to data storage 124) and associated with an account of the user.

FIG. 7 illustrates components of a machine 700, according to some example implementations, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 7 shows a diagrammatic representation of the machine 700 in the example form of a computer device (e.g., a computer) and within which instructions 724 (e.g., software, a program, an application, an applet, an app, or other executable code) for causing the machine 700 to perform any one or more of the methodologies discussed herein may be executed, in whole or in part.

For example, the instructions 724 may cause the machine 700 to execute the flow diagram of FIG. 5 and FIG. 6. In one implementation, the instructions 724 can transform the machine 700 into a particular machine (e.g., specially configured machine) programmed to carry out the described and illustrated functions in the manner described.

In alternative implementations, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724 (sequentially or otherwise) that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more components described herein.

The machine 700 may further include a graphics display 710 (e.g., a plasma display panel (PDP), a light emitting diode (LED) display, a liquid crystal display (LCD), a projector, or a cathode ray tube (CRT), or any other display capable of displaying graphics or video). The machine 700 may also include an input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a sound card, an amplifier, a speaker, a headphone jack, or any suitable combination thereof), and a network interface device 720.

The storage unit 716 includes a machine-storage medium 722 (e.g., a tangible machine-storage medium) on which is stored the instructions 724 (e.g., software) embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered as machine-storage media (e.g., tangible and non-transitory machine-storage media). The instructions 724 may be transmitted or received over a network 726 via the network interface device 720.

In some example implementations, the machine 700 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### Executable Instructions and Machine-Storage Medium

The various memories (e.g., 704, 706, and/or memory of the processor(s) 702) and/or storage unit 716 may store one or more sets of instructions and data structures (e.g., software) 724 embodying or utilized by any one or more of the methodologies or functions described herein. These instructions, when executed by processor(s) 702 cause various operations to implement the disclosed implementations.

As used herein, the terms “machine-storage medium,” “device-storage medium,” “computer-storage medium” (referred to collectively as “machine-storage medium 722”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 722 include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 722 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 724 may further be transmitted or received over a communications network 726 using a transmission medium via the network interface device 720 and utilizing any one of a number of well-known transfer protocols (e.g., HTTP). Examples of communication networks 726 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 724 for execution by the machine 700, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example implementations, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some implementations, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example implementations, the one or more processors or processor-implemented components may be located in a single geographic location (e.g., within a home environment, an office environment, or a server farm). In other example implementations, the one or more processors or processor-implemented components may be distributed across a number of geographic locations.

### Examples

Example 1 is a method for generating and utilizing an interactive aspect ratio user interface presenting a range of aspect ratios that are applied to an image at the same time. The method comprises accessing, by an image system embodied on a server, an image; generating and causing display, by the image system, of a user interface that includes the image and an adjust tools portion, the adjust tools portion including aspect ratios; receiving, via the user interface by the image system, a selection of a plurality of the aspect ratios for application to the image; in response to receiving the selection of the plurality of aspect ratios, generating, by the image system, an image preview that applies the plurality of aspect ratios to the image at the same time; and updating, by the image system, the user interface to display the image preview.

In example 2, the subject matter of example 1 can optionally include wherein generating the image preview comprises generating an aspect ratio overlay that includes a bounding box for each of the plurality of aspect ratios; and overlaying the aspect ratio overlay on the image, the overlaying causing the image to be shown translucent.

In example 3, the subject matter of any of examples 1-2 can optionally include wherein generating the image preview comprises generating a plurality of versions of the image, each version comprising a different aspect ratio of the plurality of aspect ratios; and positioning the plurality of versions of the image side by side.

In example 4, the subject matter of any of examples 1-3 can optionally include receiving a selection of an aspect ratio of the plurality of aspect ratios; and in response to receiving the selection of the aspect ratio, causing a portion of the image within a bounding box corresponding to the selected aspect ratio to become transparent.

In example 5, the subject matter of any of examples 1-4 can optionally include receiving a selection of the bounding box corresponding to the selected aspect ratio; receiving an indication to move the bounding box corresponding to the selected aspect ratio to a different area of the image; and in response to receiving the indication, causing a portion of the image within the moved bounding box to be transparent and causing any portions outside of the moved bounding box to be translucent.

In example 6, the subject matter of any of examples 1-5 can optionally include receiving a selection of the bounding box corresponding to the selected aspect ratio; receiving an indication to resize the bounding box corresponding to the selected aspect ratio; and in response to receiving the indication, resizing the bounding box, causing a portion of the image within the resized bounding box to be transparent and causing any portions outside of the resized bounding box to be translucent.

In example 7, the subject matter of any of examples 1-6 can optionally include receiving a selection of an apply trigger to apply the selected aspect ratio to the image; and in response to receiving the selection of the apply trigger, applying the selected aspect ratio to the image by cropping the image to the selected aspect ratio.

In example 8, the subject matter of any of examples 1-7 can optionally include receiving a selection of a second aspect ratio of the plurality of aspect ratios; and in response to receiving the selection of the second aspect ratio, causing a portion of the image within a bounding box corresponding to the second aspect ratio to be transparent and causing any portions outside of the bounding box corresponding to the second aspect ratio to be translucent.

In example 9, the subject matter of any of examples 1-8 can optionally include wherein receiving the selection of a plurality of the aspect ratios comprises receiving a selection of an ALL icon, the ALL icon causing all applicable aspect ratios to be applied.

In example 10, the subject matter of any of examples 1-9 can optionally include receiving a selection of a custom icon; and in response to response to receiving the selection of the custom icon, providing a field in which one or more custom aspect ratios are entered, wherein the plurality of aspect ratios include the one or more custom aspect ratios.

In example 11, the subject matter of any of examples 1-10 can optionally include receiving an indication to share the image with an external site; and in response to receiving the indication to share, determining aspect ratios corresponding to the external site, wherein the plurality of aspect ratios include the aspect ratios corresponding to the external site.

In example 12, the subject matter of any of examples 1-11 can optionally include wherein receiving the selection of the plurality of the aspect ratios for application to the image is automatic based on the indication to share.

Example 13 is a system for generating and utilizing an interactive aspect ratio user interface presenting a range of aspect ratios that are applied to an image at the same time. The system comprises one or more processors and a memory storing instructions that, when executed by the one or more processors, cause the one or more processors to perform operations comprising accessing, by an image system embodied on a server, an image; generating and causing display, by the image system, of a user interface that includes the image and an adjust tools portion, the adjust tools portion including aspect ratios; receiving, via the user interface by the image system, a selection of a plurality of the aspect ratios for application to the image; in response to receiving the selection of the plurality of aspect ratios, generating, by the image system, an image preview that applies the plurality of aspect ratios to the image at the same time; and updating, by the image system, the user interface to display the image preview.

In example 14, the subject matter of example 13 can optionally include wherein generating the image preview comprises generating an aspect ratio overlay that includes a bounding box for each of the plurality of aspect ratios; and overlaying the aspect ratio overlay on the image, the overlaying causing the image to be shown translucent.

In example 15, the subject matter of any of examples 13-14 can optionally include wherein generating the image preview comprises generating a plurality of versions of the image, each version comprising a different aspect ratio of the plurality of aspect ratios; and positioning the plurality of versions of the image side by side.

In example 16, the subject matter of any of examples 13-15 can optionally include wherein the operations further comprise receiving a selection of an aspect ratio of the plurality of aspect ratios; and in response to receiving the selection of the aspect ratio, causing a portion of the image within a bounding box corresponding to the selected aspect ratio to become transparent.

In example 17, the subject matter of any of examples 13-16 can optionally include wherein the operations further comprise receiving a selection of the bounding box corresponding to the selected aspect ratio; receiving an indication to move or resize the bounding box corresponding to the selected aspect ratio; and in response to receiving the indication, causing a portion of the image within the moved or resized bounding box to be transparent and causing any portions outside the moved or resized bounding box to be translucent.

In example 18, the subject matter of any of examples 13-17 can optionally include wherein the operations further comprise receiving a selection of a custom icon; and in response to response to receiving the selection of the custom icon, providing a field in which one or more custom aspect ratios are entered, wherein the plurality of aspect ratios include the one or more custom aspect ratios.

In example 19, the subject matter of any of examples 13-18 can optionally include wherein the operations further comprise receiving an indication to share the image with an external site; and in response to receiving the indication to share, determining aspect ratios corresponding to the external site, wherein the plurality of aspect ratios include the aspect ratios corresponding to the external site.

Example 20 is a computer-storage medium comprising instructions which, when executed by one or more processors of a machine, cause the machine to perform operations for generating and utilizing an interactive aspect ratio user interface presenting a range of aspect ratios that are applied to an image at the same time. The operations comprise accessing, by an image system embodied on a server, an image; generating and causing display, by the image system, of a user interface that includes the image and an adjust tools portion, the adjust tools portion including aspect ratios; receiving, via the user interface by the image system, a selection of a plurality of the aspect ratios for application to the image; in response to receiving the selection of the plurality of aspect ratios, generating, by the image system, an image preview that applies the plurality of aspect ratios to the image at the same time; and updating, by the image system, the user interface to display the image preview.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present invention as represented by the appended claims. The specification and drawings are, accordingly, to be regarded in an illustrative rather than a restrictive sense.

What is claimed is:

1. A method comprising:
accessing, by an image system embodied on a server, an image;
generating and causing display, by the image system, of a user interface that includes the image and an adjust tools portion, the adjust tools portion including aspect ratios;
receiving, via the user interface by the image system, a selection of a plurality of the aspect ratios for application to the image;
in response to receiving the selection of the plurality of aspect ratios, generating, by the image system, an image preview that applies the plurality of aspect ratios to the image at the same time; and
updating, by the image system, the user interface to display the image preview.

2. The method of claim 1, wherein generating the image preview comprises:
generating an aspect ratio overlay that includes a bounding box for each of the plurality of aspect ratios; and
overlaying the aspect ratio overlay on the image, the overlaying causing the image to be shown translucent.

3. The method of claim 1, wherein generating the image preview comprises:
generating a plurality of versions of the image, each version comprising a different aspect ratio of the plurality of aspect ratios; and
positioning the plurality of versions of the image side by side.

4. The method of claim 1, further comprising:
receiving a selection of an aspect ratio of the plurality of aspect ratios; and
in response to receiving the selection of the aspect ratio, causing a portion of the image within a bounding box corresponding to the selected aspect ratio to become transparent.

5. The method of claim 4, further comprising:
receiving a selection of the bounding box corresponding to the selected aspect ratio;
receiving an indication to move the bounding box corresponding to the selected aspect ratio to a different area of the image; and
in response to receiving the indication, causing a portion of the image within the moved bounding box to be transparent and causing any portions outside of the moved bounding box to be translucent.

6. The method of claim 4, further comprising:
receiving a selection of the bounding box corresponding to the selected aspect ratio;
receiving an indication to resize the bounding box corresponding to the selected aspect ratio; and
in response to receiving the indication, resizing the bounding box, causing a portion of the image within the resized bounding box to be transparent and causing any portions outside of the resized bounding box to be translucent.

7. The method of claim 4, further comprising:
receiving a selection of an apply trigger to apply the selected aspect ratio to the image; and
in response to receiving the selection of the apply trigger, applying the selected aspect ratio to the image by cropping the image to the selected aspect ratio.

8. The method of claim 4, further comprising:
receiving a selection of a second aspect ratio of the plurality of aspect ratios; and
in response to receiving the selection of the second aspect ratio, causing a portion of the image within a bounding box corresponding to the second aspect ratio to be transparent and causing any portions outside of the bounding box corresponding to the second aspect ratio to be translucent.

9. The method of claim 1, wherein receiving the selection of a plurality of the aspect ratios comprises receiving a selection of an ALL icon, the ALL icon causing all applicable aspect ratios to be applied.

10. The method of claim 1, further comprising:
receiving a selection of a custom icon; and
in response to response to receiving the selection of the custom icon, providing a field in which one or more custom aspect ratios are entered, wherein the plurality of aspect ratios include the one or more custom aspect ratios.

11. The method of claim 1, further comprising:
receiving an indication to share the image with an external site; and
in response to receiving the indication to share, determining aspect ratios corresponding to the external site, wherein the plurality of aspect ratios include the aspect ratios corresponding to the external site.

12. The method of claim 11, wherein receiving the selection of the plurality of the aspect ratios for application to the image is automatic based on the indication to share.

13. A system comprising:
one or more processors; and
a memory storing instructions that, when executed by the one or more processors, cause the one or more processors to perform operations comprising:
accessing, by an image system embodied on a server, an image;
generating and causing display, by the image system, of a user interface that includes the image and an adjust tools portion, the adjust tools portion including aspect ratios;
receiving, via the user interface by the image system, a selection of a plurality of the aspect ratios for application to the image;
in response to receiving the selection of the plurality of aspect ratios, generating, by the image system, an image preview that applies the plurality of aspect ratios to the image at the same time; and
updating, by the image system, the user interface to display the image preview.

14. The system of claim 13, wherein generating the image preview comprises:
generating an aspect ratio overlay that includes a bounding box for each of the plurality of aspect ratios; and
overlaying the aspect ratio overlay on the image, the overlaying causing the image to be shown translucent.

15. The system of claim 13, wherein generating the image preview comprises:
generating a plurality of versions of the image, each version comprising a different aspect ratio of the plurality of aspect ratios; and
positioning the plurality of versions of the image side by side.

16. The system of claim 13, wherein the operations further comprise:
receiving a selection of an aspect ratio of the plurality of aspect ratios; and
in response to receiving the selection of the aspect ratio, causing a portion of the image within a bounding box corresponding to the selected aspect ratio to become transparent.

17. The system of claim 16, wherein the operations further comprise:
receiving a selection of the bounding box corresponding to the selected aspect ratio;
receiving an indication to move or resize the bounding box corresponding to the selected aspect ratio; and
in response to receiving the indication, causing a portion of the image within the moved or resized bounding box to be transparent and causing any portions outside the moved or resized bounding box to be translucent.

18. The system of claim 13, wherein the operations further comprise:
receiving a selection of a custom icon; and
in response to response to receiving the selection of the custom icon, providing a field in which one or more custom aspect ratios are entered, wherein the plurality of aspect ratios include the one or more custom aspect ratios.

19. The system of claim 13, wherein the operations further comprise:
receiving an indication to share the image with an external site; and
in response to receiving the indication to share, determining aspect ratios corresponding to the external site, wherein the plurality of aspect ratios include the aspect ratios corresponding to the external site.

20. A machine-storage medium comprising instructions which, when executed by one or more processors of a machine, cause the machine to perform operations comprising:
accessing, by an image system embodied on a server, an image;
generating and causing display, by the image system, of a user interface that includes the image and an adjust tools portion, the adjust tools portion including aspect ratios;
receiving, via the user interface by the image system, a selection of a plurality of the aspect ratios for application to the image;
in response to receiving the selection of the plurality of aspect ratios, generating, by the image system, an image preview that applies the plurality of aspect ratios to the image at the same time; and
updating, by the image system, the user interface to display the image preview.
